(19) United States
(12) Patent Application Publication
(10) Pub. No.: US 2009/0264292 A1
(43) Pub. Date: Oct. 22, 2009

(54) HERBICIDAL COMPOSITION

(75) Inventors: Hiroshi Yoshii, Shiga (JP); Ken Ohno, Shiga (JP); Ryu Yamada, Shiga (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ISHIHARA SANGYO KAISHA, LTD., Osaka-shi (JP)

(21) Appl. No.: 12/063,767

(22) PCT Filed: Sep. 13, 2006
(86) PCT No.: PCT/JP2006/318555

§ 371 Date: Feb. 14, 2008

(30) Foreign Application Priority Data
Sep. 28, 2005 (JP) 2005-282988
Mar. 30, 2006 (JP) 2006-093026

(51) Int. Cl. A01N 43/70; A01P 13/00

(52) U.S. Cl. 504/134

(57) ABSTRACT

Many herbicidal compositions have been developed and practically used. However, types of weeds to be controlled are also many, and their emergence extends over a long period. Accordingly, it is desired that a herbicidal composition be developed which has a wider herbicidal spectrum and which is highly active and has a long lasting effect. As a result of a research to solve such problems, the present inventors have found it possible to obtain a highly practical herbicidal composition by a combined use of (A) 2-(4,6-dimethoxypyrimidin-2-ylcarbamoylsulfamoyl)-N,N-dimethylnicotinamide or its salt and (B) N²-tert-butyl-6-chloro-N⁴-ethyl-1,3,5-triazine-2,4-diamine or its salt, and thus have accomplished the present invention.

### TECHNICAL FIELD

The present invention relates to a herbicidal composition comprising (A) 2-(4,6-dimethoxypyrimidin-2-ylcarbamoylsulfamoyl)-N,N-dimethylnicotinamide or its salt (hereinafter-referred to simply as compound A) and (B) N²-tert-butyl-6-chloro-N⁴-ethyl-1,3,5-triazine-2,4-diamine or its salt (hereinafter referred to simply as compound B).

### BACKGROUND ART

Patent Document 1 discloses compound A but does not disclose its combined use with compound B.

Patent Document 1: EP0232067A

### DISCLOSURE OF THE INVENTION

### Problems to be Solved by the Invention

Many herbicidal compositions have been developed and practically used. However, types of weeds to be controlled are also many, and their emergence extends over along period. Accordingly, it is desired that a herbicidal composition be developed which has a wider herbicidal spectrum and which is highly active and has a long lasting effect.

### Means to Solve the Problems

The present inventors have conducted a research to solve the above problems and as a result, have found it possible to obtain a highly practical herbicidal composition.

Namely, the present invention provides a herbicidal composition comprising (A) compound A i.e. 2-(4,6-dimethoxypyrimidin-2-ylcarbamoylsulfamoyl)-N,N-dimethylnicotinamide (common name: nicosulfuron) or its salt and (B) compound B i.e. N²-tert-butyl-6-chloro-N⁴-ethyl-1,3,5-triazine-2,4-diamine (common name: terbuthylazine) or its salt.

Further, the present invention provides a method for controlling undesired plants or inhibiting their growth, which comprises applying a herbicidally effective amount of the herbicidal composition to the undesired plants or to a place where they grow.

Further, the present invention provides a method for controlling undesired plants or inhibiting their growth, which comprises applying herbicidally effective amounts of compounds A and B to the undesired plants or to a place where they grow.

### EFFECTS OF THE INVENTION

The herbicidal composition of the present invention, i.e. the herbicidal composition comprising compounds A and B, is capable of controlling a wide range of weeds emerging in cropland and non-cropland, and it surprisingly presents a synergistic herbicidal effect i.e. a herbicidal effect higher than the mere addition of the respective herbicidal effects of the active ingredients. With such a herbicidal composition of the present invention, not only it can be applied at a low dose as compared with a case where the respective active ingredients are applied individually, but also the herbicidal spectrum will be enlarged, and further the herbicidal effects will last over a long period of time.

When the herbicidal activity in a case where two active ingredients are combined, is larger than the simple sum of the respective herbicidal activities of the two active ingredients (the expected activity), it is called a synergistic effect. The activity expected by the combination of two active ingredients can be calculated as follows (Colby S. R., “Weed”, vol. 15, p. 20-22, 1967).

E=α+β−(α×β÷100)

where α: growth inhibition rate when treated with x (g/a) of herbicide X,

β: growth inhibition rate when treated with y (g/a) of herbicide Y,

E: growth inhibition rate expected when treated with x (g/a) of herbicide X and y (g/a) of herbicide Y.

Namely, when the actual growth inhibition rate (observed value) is larger than the growth inhibition rate by the above calculation (expected value), the activity by the combination can be regarded as showing a synergistic effect. The herbicidal composition of the present invention shows a synergistic effect when calculated by the above formula.

### BEST MODE FOR CARRYING OUT THE INVENTION

The salt included in compound A or B may be any salt so long as it is agriculturally acceptable, and it may, for example, be an alkali metal salt such as a sodium salt or a potassium salt; an alkaline earth metal salt such as a magnesium salt or a calcium salt; an ammonium salt such as a monomethylammonium salt, a dimethylammonium salt or a triethylammonium salt an inorganic acid salt such as a hydrochloride, a perchlorate, a sulfate or a nitrate; or an organic acid salt such as an acetate or a methanesulfonate.

As compound A, compounds having different crystal forms may sometimes be obtained depending upon the production conditions. The present invention includes all of such compounds, and it also includes compounds having such compounds hydrated.

In the present invention, the mix ratio of compound A and compound B varies depending upon various conditions such as the formulation, weather conditions, the types and growth conditions of the plants to be controlled and can not generally be defined. However, for example, compound B is in an amount of from 0.5 to 1,000 parts by weight, preferably from 0.5 to 600 parts by weight, more preferably from 0.5 to 500 parts by weight, particularly preferably from 1 to 250 parts by weight, per 1 part by weight of compound A.

The present invention includes the herbicidal composition having the above-mentioned mix ratio, and a method for controlling undesired plants or inhibiting their growth, which comprises applying a herbicidally effective amount of the herbicidal composition. In its application, the application to the undesired plants or the application to a place where they grow (either before or after the emergence of the undesired plants) may optionally be selected.

The application amount of the herbicidal composition of the present invention can not generally be defined, since it varies depending upon various conditions such as the mix ratio of compound A and compound B, the formulation, weather conditions, the types and growth conditions of the plants to be controlled. However, compound A is usually from 1 to 200 g/ha, preferably from 2.5 to 100 g/ha, and compound B is usually from 100 to 5,000 g/ha, preferably from 200 to 2,500 g/ha. And, the suitable total application amount of compounds A and B is usually from 101 to 5,200 g/ha, preferably from 202.5 to 2,600 g/ha.

The present invention includes a method for controlling undesired plants or inhibiting their growth, which comprises applying compound A and compound B in the respectively above-mentioned application amounts or applying them in the above-mentioned suitable total application amount. In the application, the application to the undesired plants or the application to a place where they grow (either before or after the emergence of the undesired plants) may optionally be selected.

The herbicidal composition of the present invention is capable of controlling a wide range of undesired plants such as annual weeds and perennial weeds, at a low dose. The undesired plants include grasses (or gramineae) such as barnyardgrass (Echinochloa crus-galli L.), crabgrass (Digitaria sanguinalis L.), greenfoxtail (Setaria viridis L.), giant foxtail (Setaria faberi Herrm.), goosegrass (Eleusine indica L.), wild oat (Avena fatua L.), johnsongrass (Sorghum halepense L.), quackgrass (Agropyron repens L.), alexandergrass (Brachiaria plantaginea), paragrass (Panicum purpurascens), sprangletop (Leptochloa chinensis), red sprangletop (Leptochloa panicea), annual bluegrass (Poa annua L.), black grass (Alopecurus myosuroides Huds.) and cholorado bluestem (Agropyron tsukushiense (Honda) Ohwi); sedges (or Cyperaceae) such as rice flatsedge (Cyperus iria L.), purple nutsedge (Cyperus rotundus L.), yellow nutsedge (Cyperus esculentus L.), flatsedge (Cyperus serotinus) and small-flower umbrellaplant (Cyperus difformis); and broad leaves such as velvetleaf (Abutilon theophrasti MEDIC.), tall morningglory (Ipomoea purpurea L.), common lambsquarters (Chenopodium album L.), prickly sida (Sida spinosa L.), common purslane (Portulaca oleracea L.), slender amaranth (Amaranthus viridis L.), redroot pigweed (Amaranthus retroflexus L.), sicklepod (Cassia obtusifolia L.), black nightshade (Solanum nigrum L.), pale smartweed (Polygonum lapathifolium L.), common chickweed (Stellaria media L.), longstem waterwort (Elatine triandra SCHK.), common cocklebur (Xanthium strumarium L.), flexuous bittercress (Cardamine flexuosa WITH.), henbit (Lamium amplexicaule L.), common ragweed (Ambrosia elatior L.), catchweed (Galium spurium L.), field bindweed (Calystegia arvensis L.), jimsonweed (Datura stramonium), thistle (Breea setosa (BIEB.) KITAM.) and threeseeded coaperleaf (Acalypha australis L.). Further, the herbicidal composition of the present invention is capable of providing good effects when applied at either stage of before or after the germination of the weeds.

The herbicidal composition of the present invention may take various application forms such as oil application, foliar application, irrigation and water application and is useful for controlling undesired plants in agricultural fields such as upland fields, orchards or paddy fields, or non-agricultural fields such as levee, fallow field, play grounds, vacant grounds, forests, factory sites, railway sides or road sides.

Further, so long as the object of the present invention is met, the composition of the present invention may further contain another herbicidally active ingredient in addition to the above described active ingredients, whereby it may sometimes be possible to improve e.g. the herbicidal activities, the timing for: the application of the herbicide or the range of the weeds to be controlled. Such another herbicidally active ingredient includes, for example, the following compounds common names including ones under application for approval by ISO, or developing codes). Even when not specifically mentioned here, in a case where such compounds have salts, alkyl esters, optical isomers, etc., they are, of course, all included.

(1) Those which are believed to exhibit herbicidal effects by disturbing hormone activities of plants, such as a phenoxy type such as 2,4-D, 2,4-DB, 2,4-DP, MCPA, MCPB, MCPP, naproanilide or clomeprop, an aromatic carboxylic acid type such as 2,3,6-TBA, dicamba, dichlobenil, picloram, triclopyr, clopyralid or aminopyralid, and others such as naptalam, benazolin, quinclorac, quinmerac, diflufenzopyr and thiazopyr.

(2) Those which are believed to exhibit herbicidal effects by inhibiting photosynthesis of plants, such as a urea type such as chlorotoluron, diuron, fluometuron, linuron, isoproturon, metobenzuron or tebuthiuron, a triazine type such as simazine, atrazine, atratone, simetryn, prometryn, dimethametryn, hexazinone, metribuzin, cyanazine, ametryn, cybutryne, triaziflam or propazine, a uracil type such as bromacil, lenacil or terbacil, an anilide type such as propanil or cypromid, a carbamate type such as swep, desmedipham or phenmedipham, a hydroxybenzonitrile type such as bromoxynil, bromoxynil-octanoate or ioxynil, and others such as pyridate, bentazone, amicarbazone and methazole.

(3) Quaternary ammonium salt type such as paraquat or diquat, which is believed to be converted to free radicals by itself to form active oxygen in the plant body.

(4) Those which are believed to exhibit herbicidal effects by inhibiting chlorophyll biosynthesis of plants and abnormally accumulating a photosensitizing peroxide substance in the plant body, such as a diphenylether type such as nitrofen, chlomethoxyfen, bifenox, acifluorfen-sodium, fomesafen, oxyfluorfen, lactofen or ethoxyfen-ethyl, a cyclic imide type such as chlorphthalim, flumioxazin, flumiclorac-pentyl or fluthiacet-methyl, and others such as oxadiargyl, oxadiazon, sulfentrazone, carfentrazone-ethyl, thidiazimin, pentoxazone, azafenidin, isopropazole, pyraflufen-ethyl, benzfendizone, butafenacil, metobenzuron, cinidon-ethyl, flupoxam, fluazolate, profluazol, pyrachlonil, flufenpyr-ethyl and bencarbazone.

(5) Those which are believed to exhibit herbicidal effects characterized by whitening activities by inhibiting chromogenesis of plants such as carotenoids, such as a pyridazinone type such as norflurazon, chloridazon or metflurazon, a pyrazole type such as pyrazolate, pyrazoxyfen, benzofenap, topramezone (BAS-670H) or pyrasulfotole, and others such as amitrol, fluridone, flurtamone, diflufenican, methoxyphenone, clomazone, sulcotrione, mesotrione, tembotrione, tefuryltrione (AVH-301), isoxaflutole, difenzoquat, isoxachlortole, benzobicyclon, picolinafen and beflubutamid.

(6) Those which exhibit strong herbicidal effects specifically to gramineous plants, such as an aryloxyphenoxypropionic acid type such as diclofop-methyl, flamprop-M-methyl, pyriphenop-sodium, fluazifop-butyl, haloxyfop-methyl, quizalofop-ethyl, cyhalofop-butyl, fenoxaprop-ethyl or metamifop-propyl, and a cyclohexanedione type such as alloxydim-sodium, clethodim, sethoxydim, tralkoxydim, butroxydim, tepraloxydim, caloxydim, clefoxydim or profoxydim.

(7) Those which are believed to exhibit herbicidal effects by inhibiting an amino acid biosynthesis of plants, such as a sulfonylurea type such as chlorimuron-ethyl, sulfometuron-methyl, primisulfuron-methyl, bensulfuron-methyl, chlorsulfuron, metsulfuron-methyl, cinosulfuron, pyrazosulfuron-ethyl, azimsulfuron, flazasulfuron, rimsulfuron, imazosulfuron, cyclosulfamuron, prosulfuron, flupyrsulfuron, triflusulfuron-methyl, halosulfuron-methyl, thifensulfuron-methyl, ethoxysulfuron, oxasulfuron, ethametsulfuron, iodosulfuron, sulfosulfuron, triasulfuron, tribenuron-methyl, tritosulfuron, foramsulfuron, trifloxysulfuron, isosulfuron-methyl, mesosulfuron-methyl, orthosulfamuron, flucetosulfuron, amidosulfuron, TH-547 of a compound disclosed in WO2005092104, a triazolopyrimidinesulfonamide type such as flumetsulam, metosulam, diclosulam, cloransulam-methyl, florasulam, metosulfam or penoxsulam, an imidazolinone type such as imazapyr, imazethapyr, imazaquin, imazamox, imazameth, imazamethabenz or imazapic, a pyrimidinylsalicylic acid type such as pyrithiobac-sodium, bispyribac-sodium, pyriminobac-methyl, pyribenzoxim, pyriftalid or pyrimisulfan (KUH-021), a sulfonylaminocarbonyltriazolinone type such as flucarbazone or procarbazone-sodium, and others such as glyphosate, glyphosate-ammonium, glyphosate-isopropylamine, sulfosate, glufosinate, glufosinate-ammonium and bilanafos.

(8) Those which are believed to exhibit herbicidal effects by inhibiting cell mitoses of plants, such as a dinitroaniline type such as trifluralin, oryzalin, nitralin, pendimethalin, ethalfluralin, benfluralin or prodiamine, an amide type such as bensulide, napronamide or pronamide, an organic phosphorus type such as amiprofos-methyl, butamifos, anilofos or piperophos, a phenylcarbamate type such as propham, chlorpropham or barban, a cumylamine type such as daimuron, cumyluron or bromobutide, and others such as asulam, dithiopyr, thiazopyr, cafenstrole and indanofan.

(9) Those which are believed to exhibit herbicidal effects by inhibiting protein biosynthesis or lipid biosynthesis of plants, such as a chloroacetamide type such as alachlor, metazachlor, butachlor, pretilachlor, metolachlor, S-metolachlor, thenylchlor, pethoxamid, acetochlor, propachlor propisochlor, a carbamate type such as molinate, dimepiperate or pyributicarb, and others such as etobenzanid, mefenacet, flufenacet, tridiphane, fentrazamide, oxaziclomefone, dimethenamid and benfuresate.

(10) A thiocarbamate type such as EPTC, butylate, vernolate, pebulate, cycloate, prosulfocarb, esprocarb, thiobencarb, diallate or triallate, and others such as MSMA, DSMA, endothall, ethofumesate, sodium chlorate, pelargonic acid, fosamine, pinoxaden and HOK-201.

(11) Those which are believed to exhibit herbicidal effects by being parasitic on plants, such as Xanthomonas campestris, Epicoccosurus nematosurus, Exserohilum monoseras and Drechsrela monoceras.

The herbicidal composition of the present invention may be prepared by mixing compound A and compound B, as active ingredients, with various additives in accordance with conventional formulation methods for agricultural chemicals, and applied in the form of various formulations such as dusts, granules, water dispersible granules, wettable powders, tablets, pills, capsules (including a formulation packaged by a water soluble film), water-based suspensions, oil-based suspensions, microemulsions, suspoemulsions, water soluble powders, emulsifiable concentrates, soluble concentrates or pastes. It may be formed into any formulation which is commonly used in this field, so long as the object of the present invention is thereby met.

At the time of the formulation, compound A and compound B may be mixed together for the formulation or they may be separately formulated and mixed together at the time of the application.

The additives to be used for the formulation include, for example, a solid carrier such as diatomaceous earth, slaked lime, calcium-carbonate, talc, white carbon, kaoline, bentonite, a mixture of kaolinite and sericite, clay, sodium carbonate, sodium bicarbonate, mirabilite, zeolite or starch; a solvent such as water, toluene, xylene, solvent naphtha, dioxane, acetone, isophorone, methyl isobutyl ketone, chlorobenzene, cyclohexane, dimethyl sulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenyl ether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or an alkylnaphthalene sulfonate condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used. The mix ratio by weight of the active ingredients to such various additives in the herbicidal composition of the present invention may be from 0.001:99.999 to 95:5, preferably from 0.005:99.995 to 90:10.

As a method for applying the herbicidal composition of the present invention, various methods may be employed and may suitably be selected for use depending upon various conditions such as the application sites, the formulations, the types or growth conditions of the plants to be controlled. For example, the following methods may be mentioned.

1. Compound A and compound B are mixed together to prepare a formulation, which is applied as it is.
2. Compound A and compound B are mixed together to prepare a formulation which is diluted to a predetermined concentration with e.g. water, and, if necessary, various additives (a surfactant, a vegetable oil, a mineral oil, etc.) are added, followed by the application.
3. Compound A and compound B are separately formulated and applied as formulated.
4. Compound A and compound B are separately formulated and respectively diluted to the predetermined concentrations with e.g. water and, if necessary, various additives (a surfactant, a vegetable oil, a mineral oil, etc.) are added, followed by the application.
5. Compound A and compound B are separately formulated and then mixed at the time of diluting them to the predetermined concentrations by e.g. water, and if necessary, various additives (a surfactant, a vegetable oil, a mineral oil, etc.) are added, followed by the application.

Now, some preferred embodiments of the present invention will be exemplified. However, the present invention is by no means restricted thereto.

(1) A herbicidal composition comprising 2-(4,6-dimethoxypyrimidin-2-ylcarbamoylsulfamoyl)-N,N-dimethylnicotinamide (hereinafter referred to simply as compound A-1) and N²-tert-butyl-6-chloro-N⁴-ethyl-1,3,5-triazine-2,4-diamine (hereinafter referred to simply as compound B-1); and a method for controlling undesired plants or inhibiting their growth, which comprises applying a herbicidally effective amount of such a herbicidal composition to the undesired plants or to a place where they grow.

(2) A method for controlling undesired plants or inhibiting their growth, which comprises applying a herbicidally effective amount of compound A-1 and a herbicidally effective amount of compound B-1 to the undesired plants or to a place where they grow.

### EXAMPLES

Now, Formulation Examples for the herbicidal composition of the present invention will be described, but the present invention is by no means restricted thereto.

### Formulation Example 1

| | | | |
|---|---|---|---|
| (1) | Compound A-1 | 1 | part by weight |
| (2) | Compound B-1 | 20 | parts by weight |
| (3) | Supragil MNS/90 (sodium | 3 | parts by weight |
| | alkylnaphthalene sulfonate | | |
| | condensed with formaldehyde) | | |
| (4) | NEWKALGEN BX-C (sodium | 4 | parts by weight |
| | dialkylnaphthalene sulfonate) | | |
| (5) | Diatomaceous earth | 72 | parts by weight |

The above respective components are mixed to obtain a wettable powder.

### Formulation Example 2

| | | | |
|---|---|---|---|
| (1) | Compound A-1 | 1 | part by weight |
| (2) | Compound B-1 | 40 | parts by weight |
| (3) | Supragil MNS/90 | 8 | parts by weight |
| (4) | Geropon T/36 (sodium | 3 | parts by weight |
| | polycarboxylate) | | |
| (5) | Kaolin | 48 | parts by weight |

The above respective components are mixed, and then water was added, followed by kneading, extrusion granulation, drying and sieving to obtain water dispersible granules.

### Formulation Example 3

| | | | |
|---|---|---|---|
| (1) | Compound A-1 | 0.3 | part by weight |
| (2) | Compound B-1 | 7.5 | parts by weight |
| (3) | GERONOL VO/278 (glycerol fatty | 10 | parts by weight |
| | acid ester) | | |
| (4) | Methyl ester of vegetable oil | 80.2 | parts by weight |
| (5) | New D Orben (Bentonite-alkylamino | 2 | parts by weight |
| | complex) | | |

The above respective components are uniformly mixed and milled by a Dyno-mill to obtain a suspension.

### Notes:

Supragil MNS/90 and Geropon T/36: tradenames, manufactured by Rhodia Nicca, Ltd.

NEWKALGEN BX-C: tradename, manufactured by TAKEMOTO OIL AND FAT Co., Ltd.

GERONOL VO/278: tradename, manufactured by Rhone-Poulenc

New D Orben: tradename, manufactured by Shiraishi Kogyo Kaisha, Ltd.

### Test Example 1

Upland field soil was put into a 1/1,000,000 ha pot, and seeds of various plants were sown. Then, when the plants reached the prescribed leaf stages ((1) 3.6 leaf stage of crabgrass (Digitaria sanguinalis L.), and (2), 2.8 leaf stage of velvetleaf (Abutilon theophrasti MEDIC.)), a prescribed amount of the herbicidal composition was diluted with water corresponding to 300 L/ha, and foliar application was carried out by means of a small size spray. On the 21st day after the application, the state of growth of each plant was visually observed, and the growth inhibition rate (%) evaluated in accordance with the following evaluation standard (observed value) and the growth inhibition rate (%) calculated by the above-mentioned Colby method (expected value) are shown in Tables 1 and 2 .

Growth inhibition rate (%)=0% (equivalent to the non-treated area) to 100% (complete kill)

TABLE 1

| | Amount of application | Crabgrass | |
|---|---|---|---|
| | of active ingredients | Growth inhibition rate (%) | |
| Compound | (g/ha) | Observed | Expected |
| A-1 | 25 | 53 | — |
| B-1 | 250 | 5 | — |
| | 500 | 8 | — |
| A-1 + B-1 | 25 + 250 | 66 | 55 |
| | 25 + 500 | 67 | 58 |

TABLE 2

| | Amount of application | Velvetleaf | |
|---|---|---|---|
| | of active ingredients | Growth inhibition rate (%) | |
| Compound | (g/ha) | Observed | Expected |
| A-1 | 50 | 60 | — |
| B-1 | 250 | 57 | — |
| | 500 | 58 | — |
| A-1 + B-1 | 50 + 250 | 88 | 83 |
| | 50 + 500 | 100 | 83 |

### Test Example 2

Upland field soil was put into a 1/1,000,000 ha pot, and seeds of velvetleaf (Abutilon theophrasti MEDIC.) were sown. Then, when velvetleaf reached 2.9 leaf stage, a prescribed amount of the herbicidal composition was diluted with water corresponding to 300 L/ha, and foliar application was carried out by means of a small size spray.

On the 21st day after the application, the state of growth of velvetleaf was visually observed and evaluated in the same manner as in the above Test Example 1. The results are shown in Table 3.

TABLE 3

| | Amount of application | Velvetleaf | |
|---|---|---|---|
| | of active ingredients | Growth inhibition rate (%) | |
| Compound | (g/ha) | Observed | Expected |
| A-1 | 25 | 38 | — |
| B-1 | 500 | 47 | — |
| A-1 + B-1 | 25 + 500 | 70 | 67 |

### Test Example 3

Upland field soil was put into a 1/1,000,000 ha pot, and seeds of velvetleaf (Abutilon theophrasti MEDIC.) were sown. Then, when velvetleaf reached 2.3 to 2.5 leaf stage, a prescribed amount of the herbicidal composition was diluted with water corresponding to 300 L/ha, and foliar application was carried out by means of a small size spray.

On the 14th day after the application, the state of growth of velvetleaf was visually observed and evaluated in the same manner as in the above Test Example 1. The results are shown in Table 4.

TABLE 4

| | Amount of application | Velvetleaf | |
|---|---|---|---|
| | of active ingredients | Growth inhibition rate (%) | |
| Compound | (g/ha) | Observed | Expected |
| A-1 | 5 | 5 | — |
| | 10 | 8 | — |
| | 15 | 12 | — |
| B-1 | 1000 | 37 | — |
| | 1500 | 43 | — |
| | 2000 | 43 | — |
| A-1 + B-1 | 5 + 1000 | 50 | 40 |
| | 5 + 1500 | 53 | 46 |
| | 5 + 2000 | 53 | 46 |
| | 10 + 1000 | 55 | 42 |
| | 10 + 1500 | 57 | 48 |
| | 10 + 2000 | 60 | 48 |
| | 15 + 1000 | 57 | 44 |
| | 15 + 1500 | 58 | 50 |
| | 15 + 2000 | 63 | 50 |

The entire disclosures of Japanese Patent Application No. 2005-282988 filed on Sep. 28, 2005 and Japanese Patent Application No. 2006-093026 filed on Mar. 30, 2006 including specifications, claims and summaries are incorporated herein by reference in their entireties.

1. A herbicidal composition comprising (A) 2-(4,6-dimethoxypyrimidin-2-ylcarbamoylsulfamoyl)-N,N-dimethylnicotinamide or its salt and (B) N²-tert-butyl-6-chloro-N⁴-ethyl-1,3,5-triazine-2,4-diamine or its salt.

2. A method for controlling undesired plants or inhibiting their growth, which comprises applying a herbicidally effective amount of the herbicidal composition as defined in claim 1 to the undesired plants or to a place where they grow.

3. A method for controlling undesired plants or inhibiting their growth, which comprises applying herbicidally effective amounts of (A) and (B) as defined in claim 1 to the undesired plants or to a place where they grow.

4. The herbicidal composition according to claim 1, wherein the mix ratio of (A) and (B) is such that (B) is from 0.5 to 1,000 parts by weight per 1 part by weight of (A).

5. A method for controlling undesired plants or inhibiting their growth, which comprises applying a herbicidally effective amount of the herbicidal composition as defined in claim 4 to the undesired plants or to a place where they grow.

6. A method for controlling undesired plants or inhibiting their growth, which comprises applying a herbicidally effective amount of from 1 to 200 g/ha of (A) and a herbicidally effective amount of from 100 to 5,000 g/ha of (B) as defined in claim 1 to the undesired plants or to a place where they grow.
